(19) United States
(12) Patent Application Publication
(10) Pub. No.: US 2022/0214980 A1
(43) Pub. Date: Jul. 7, 2022

(54) OPTICAL TRANSCEIVER AND OPTICAL TRANSCEIVER CONTROL METHOD

(71) Applicant: SUMITOMO ELECTRIC INDUSTRIES, LTD., Osaka (JP)

(72) Inventor: Yasuhiro TANAKA, Osaka (JP)

(21) Appl. No.: 17/646,025

(22) Filed: Dec. 27, 2021

(30) Foreign Application Priority Data
Jan. 5, 2021 (JP) 2021-000568

(51) Int. Cl. G06F 13/16; H04B 10/40; G06F 13/28; G06F 13/42

(52) U.S. Cl. CPC G06F 13/1668; G06F 13/4282; G06F 13/28; H04B 10/40

(57) ABSTRACT

With respect to an optical transceiver that can communicate with a host device through a serial communication bus, the optical transceiver includes a signal processor that processes an electrical signal, a photoelectric converter that performs conversion between the electrical signal and an optical signal, a first memory that includes a first region, a second memory, an internal serial communication bus that has a data transfer rate higher than that of the serial communication bus, and a transfer part that stores a divided program received from the host device in the first region and transfers the divided program stored in the first region to the second memory through the internal serial communication bus. The transfer part starts storing of another divided program in a transferred region of the first region before the second memory completes an operation of writing the divided program to memory cells of the second memory.

### CROSS-REFERENCE TO RELATED APPLICATIONS

This application claims priority to Japanese Patent Application No. 2021-000568, filed on Jan. 5, 2021, the entire subject matter of which is incorporated herein by reference.

### BACKGROUND

### 1. Field of the Invention

The present disclosure relates to an optical transceiver and an optical transceiver control method.

### 2. Description of the Related Art

In a memory system including a host and a memory device, a method of using a direct memory access in order to perform data transfer between the host and the memory device without interference from the host is proposed (see, for example, Patent Document 1). In an information processing device, it is proposed that data transfer between a peripheral component interconnect express (PCIe) card and a main memory is performed using a direct path or a path through a local memory, depending on the number of entries in a control array for address translation. In this case, a direct memory access controller (DMAC) is used to perform data transfer to the local memory (see, for example, Patent Document 2).

In a multi-flow optical transceiver that can variably set multiple paths for transmitting optical signals, it is proposed to provide a multiplexing/demultiplexing optical switch that can couple light from a variable wavelength light source to an optional light modulation means with a desired power (see, e.g., Patent Document 3). A method of measuring the processing time at a data transmission source, the response processing time at a data transmission destination, and the consumption time at a transmission path based on a pair of the transmission time of consecutive transmitting data and the received time of a response has been proposed. For example, a search unit that searches for transmitting data corresponding to the response registers search data used for the search from an external memory to a memory of a search block by using the DMAC (see, for example, Patent Document 4).

An optical transceiver that performs conversion between an electrical signal and an optical signal includes, for example, a signal processor such as a digital signal processor (DSP) and a rewritable non-volatile memory in which a control program executed by the signal processor is stored. Additionally, the optical transceiver sequentially transfers divided programs obtained by dividing the control program into multiple pieces, to the non-volatile memory, when the capacity of a buffer used for the transfer of the control program is small. For example, because the update of the control program is performed by stopping the operation of the optical transceiver, the write time of the control program to the non-volatile memory may be preferably shorter.

### RELATED ART DOCUMENTS

### Non-Patent Document

[Patent Document 1] Japanese Translation of PCT International Application Publication No. 2012-529103

[Patent Document 2] Japanese Laid-Open Patent Publication No. 2011-186658

[Patent Document 3] International Publication Pamphlet No. 2013/012015

[Patent Document 4] Japanese Laid-Open Patent Publication No. 2010-035147

### SUMMARY

According to one aspect of the embodiment of the present disclosure, with respect to an optical transceiver that can communicate with a host device through a serial communication bus, the optical transceiver includes a signal processor configured to process an electrical signal, a photoelectric converter configured to perform conversion between the electrical signal and an optical signal, a first memory that includes a first region, a second memory accessed by the signal processor, the second memory being non-volatile, and a control program executed by the signal processor being stored in the second memory, an internal serial communication bus that has a data transfer rate higher than a data transfer rate of the serial communication bus, and a transfer part configured to store a divided program received from the host device through the serial communication bus in the first region and transfer the divided program stored in the first region to the second memory through the internal serial communication bus. The transfer part starts storing of another divided program in a transferred region of the first region before the second memory completes an operation of writing, to memory cells of the second memory, the divided program transferred by the transfer part, the another divided program being different from the divided program, the transferred region storing a portion of the divided program stored in the first region, and the portion of the divided program being transferred to the second memory.

According to at least one embodiment of the present disclosure, a control program to be executed by a signal processor mounted in an optical transceiver can be written from a host device to a non-volatile memory at a high speed.

### BRIEF DESCRIPTION OF THE DIAGRAMS

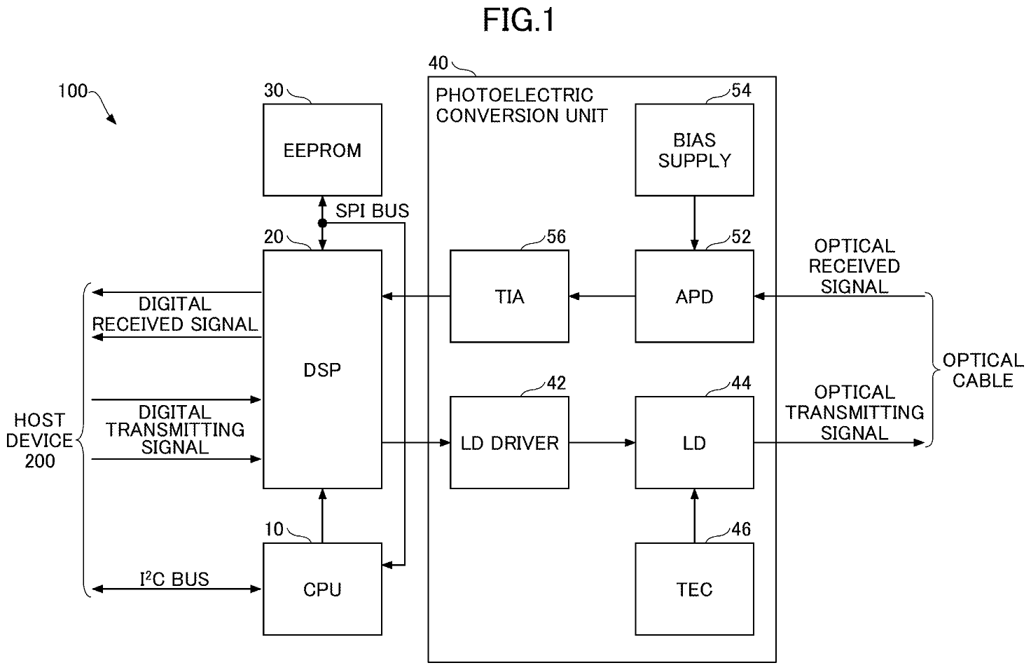

FIG. 1 is a block diagram illustrating an example configuration of an optical transceiver according to a first embodiment;

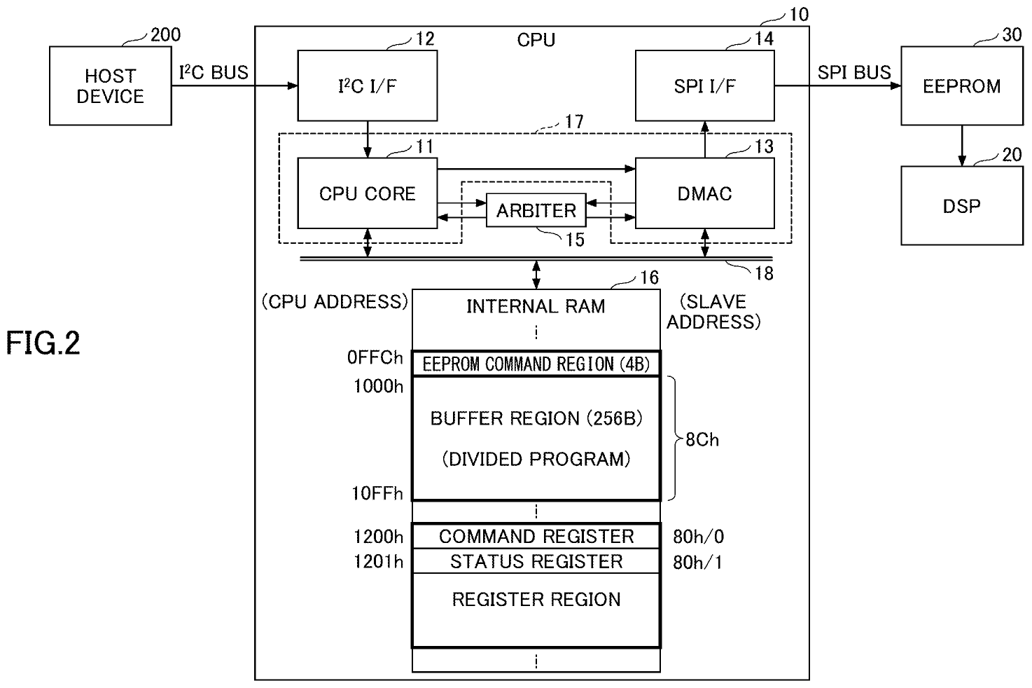

FIG. 2 is a block diagram illustrating an example of an internal configuration of a CPU of FIG. 1;

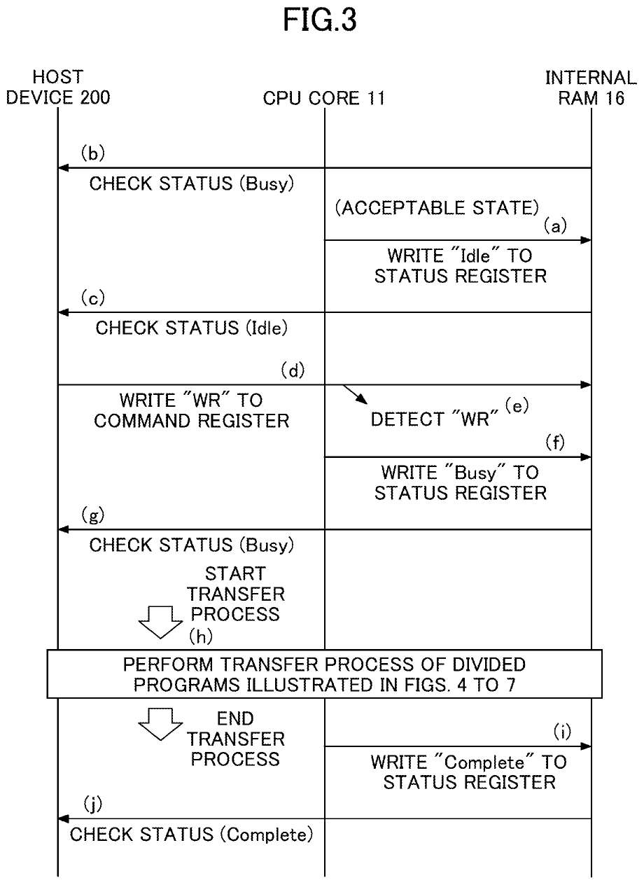

FIG. 3 is an operation sequence diagram illustrating an example of a status check when a divided program is transferred from a host device to the CPU;

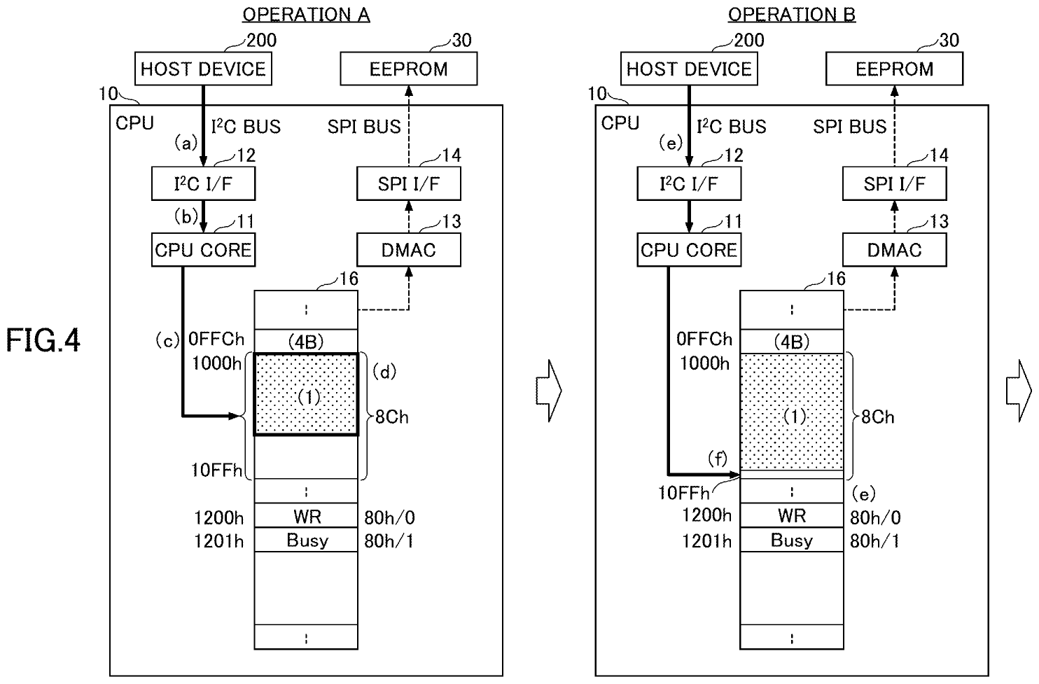

FIG. 4 is an explanatory diagram illustrating an example in which the CPU transfers, to an electrically erasable read-only memory (EEPROM), a divided program transferred from the host device to the CPU;

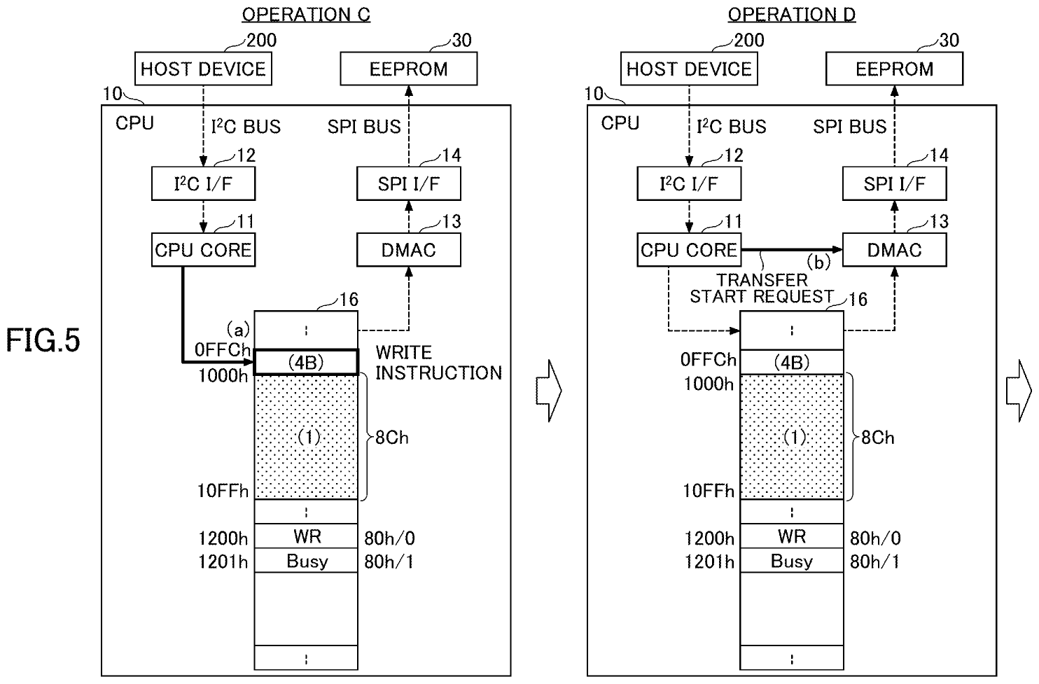

FIG. 5 is an explanatory diagram illustrating a continuation of FIG. 4;

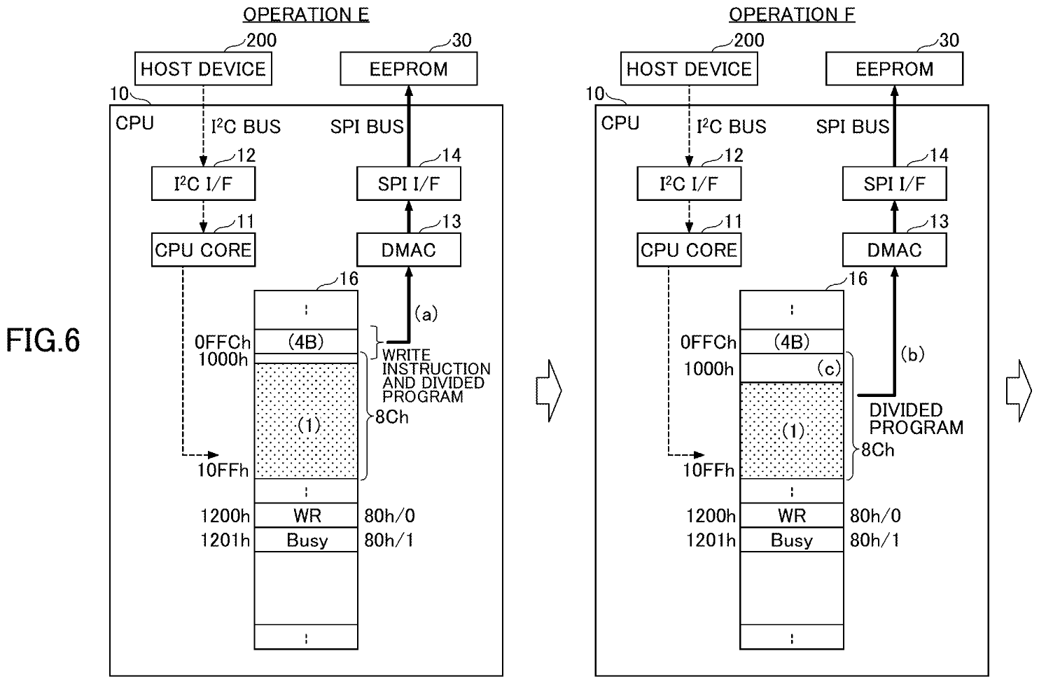

FIG. 6 is an explanatory diagram illustrating a continuation of FIG. 5;

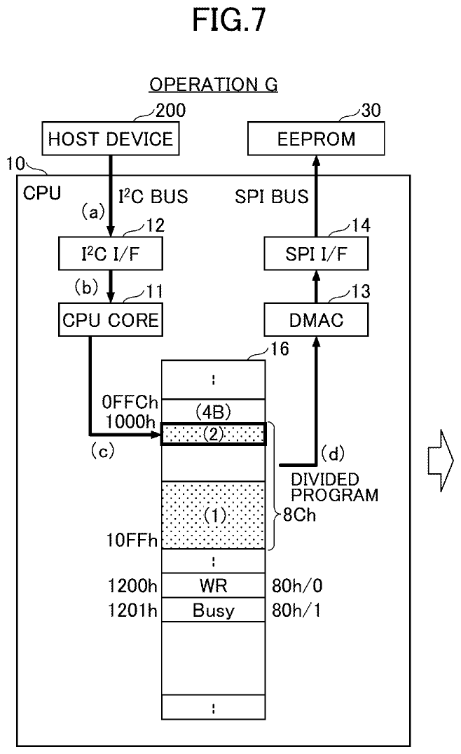

FIG. 7 is an explanatory diagram illustrating a continuation of FIG. 6;

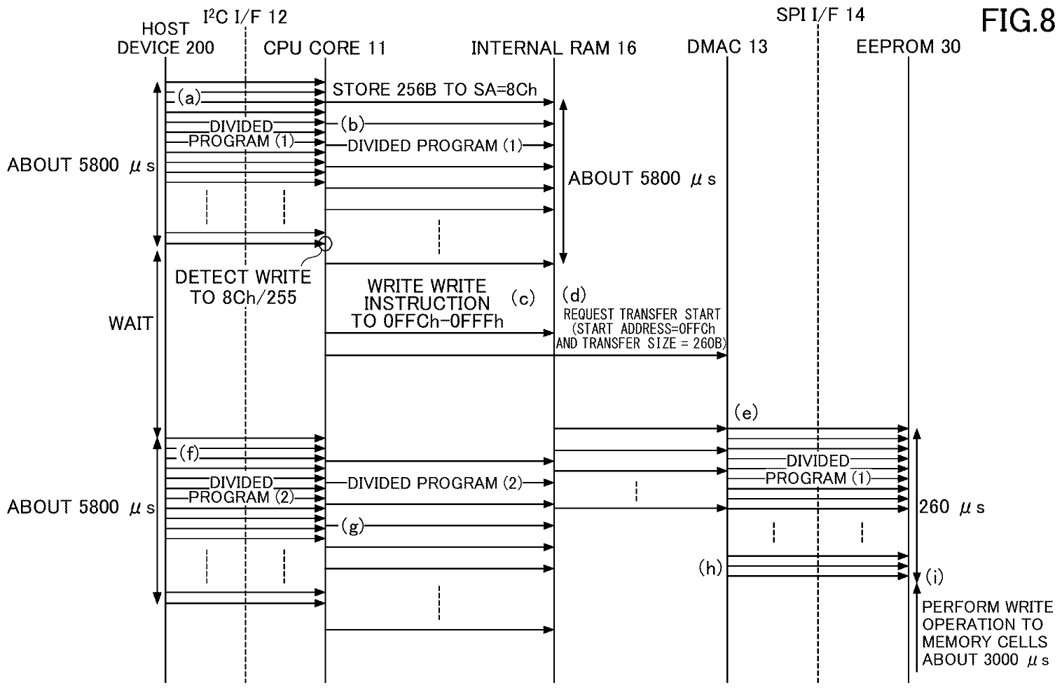

FIG. 8 is an operation sequence diagram illustrating an example in which the CPU transfers, to the EEPROM, a signal processing program for a DSP transferred from the host device; and

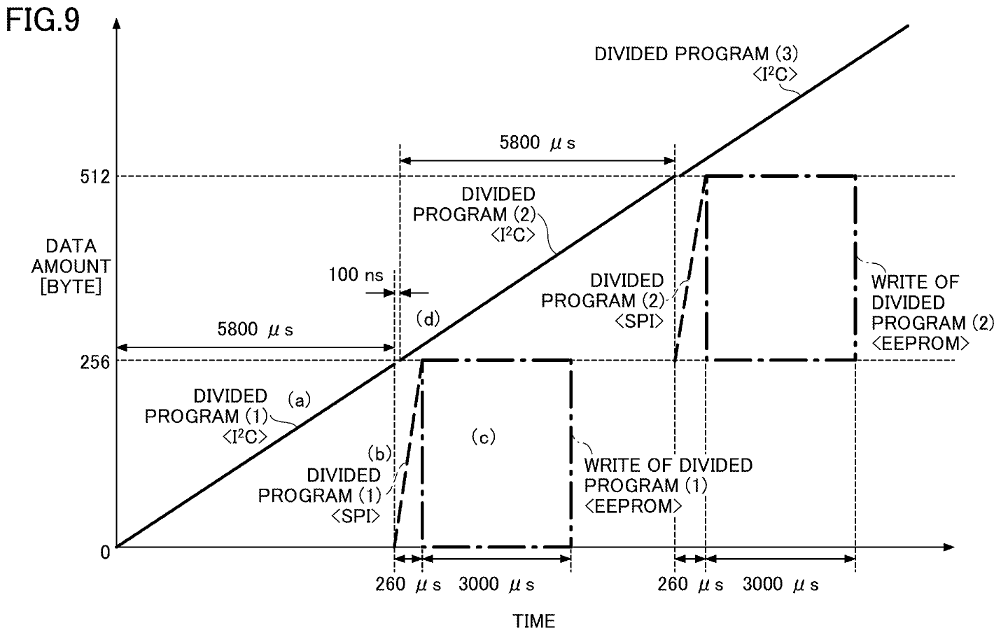

FIG. 9 is a timing diagram illustrating an example of a transfer of the divided program from the host device to an internal RAM and a transfer of the divided program from the internal RAM to the EEPROM.

### DETAILED DESCRIPTION

### Description of Embodiments of the Present Disclosure

Embodiments of the present disclosure will first be described by listing.

[1] An optical transceiver according to an aspect of the present disclosure is an optical transceiver that can communicate with a host device through a serial communication bus, and that includes a signal processor configured to process an electrical signal, a photoelectric converter configured to perform conversion between the electrical signal and an optical signal, a first memory that includes a first region, and a second memory accessed by the signal processor. The second memory is non-volatile, and a control program executed by the signal processor is stored in the second memory. The optical transceiver further includes an internal serial communication bus that has a data transfer rate higher than a data transfer rate of the serial communication bus, and a transfer part configured to store a divided program received from the host device through the serial communication bus in the first region and transfer the divided program stored in the first region to the second memory through the internal serial communication bus. The transfer part starts storing of another divided program in a transferred region of the first region before the second memory completes an operation of writing, to memory cells of the second memory, the divided program transferred by the transfer part. The another divided program is different from the divided program, the transferred region stores a portion of the divided program stored in the first region, and the portion of the divided program is transferred to the second memory.

In this optical transceiver, in parallel with the writing of the divided program transferred from the first memory to the second memory, to the second memory, the transfer of another divided program from the host device to the first memory can be performed. In other words, the divided program can be written to the second memory in the background of the transfer of another divided program to the first memory. Therefore, multiple divided programs to be executed by the signal processor mounted in the optical transceiver can be written from the host device to the second memory at a high speed. For example, when updating the control program retained in the second memory, the downtime of the optical transceiver can be minimized.

[2] In the above-described [1], the transfer part may start storing of the another divided program to the transferred area before the transfer of the divided program to the second memory through the internal serial communication bus is completed.

The data transfer rate of the internal serial communication bus is higher than the data transfer rate of the serial communication bus connected to the host device. This can prevent the divided program already retained in the first region of the first memory from being overwritten by another divided program that is transferred next. Therefore, after the transfer of the first divided program to the second memory is started, the host device can start the transfer of the subsequent divided program in sequence without checking an available space of the first memory. As a result, the transfer control of the divided program performed by the transfer part can be efficiently performed, and the divided program can be written from the host device to the second memory at a high speed.

[3] In the above-described [1] or [2], the divided program and another divided program may be programs obtained by dividing the control program. Thus, for example, even when the control program cannot be transferred from the host device at once due to the limitation of the storage capacity of the first memory, the control program can be written from the host device to the second memory at a high speed.

[4] In any of [1] to [3], the first memory includes a second region in which a control instruction for controlling the second memory is stored, and the first region may be provided contiguous to the second region. This enables the control instruction and the divided program to be continuously transferred to the second memory, thereby reducing the time required until the control program is written to the second memory.

[5] In [4], the second memory writes the divided program contiguous to the write instruction to the memory cells in response to receiving the write instruction that is one of the control instruction and the divided program contiguous to the write instruction, and the transfer part may transfer the write instruction stored in the second region and the divided program stored in the first region to the second memory continuously. This can, based on one transfer instruction (i.e., one start address), continuously transfer the control instruction and the divided program to the second memory, and start the writing of the divided program to the memory cells.

[6] In any of [1] to [5], the time required to store the divided program in the first memory may be longer than the sum of the transfer time of the divided program stored in the first memory to the second memory and the write time of the divided program to the memory cells.

In this case, upon the completion of one transfer of the divided program from the host device to the first memory, the writing of the previous divided program to the memory cells of the second memory is completed. For this reason, the host device can start the transfer of the subsequent divided program to the first memory without checking the completion of the writing of the divided program to the memory cells of the second memory. As a result, the time required to check the completion of the writing of the divided program to the second memory can be eliminated, and the time required until the control program is written to the second memory can be reduced.

[7] In any one of the above-described [1] and [6], the optical transceiver may further include a processor that controls the signal processor and the photoelectric converter and that includes the transfer part, and the transfer part may be caused to transfer the divided program by the processor executing the transfer control program. With this configuration, even when the control program is written to the second memory having a different specification, for example, by changing the transfer control program according to the specification of the second memory, the processor can sequentially transfer the divided programs to the second memory and write the divided programs to the memory cells.

[8] In [7], the processor may include a direct memory access controller, and the direct memory access controller may transfer the divided program stored in the first region to the second memory through the internal serial communication bus based on an instruction from the transfer control program. This allows the processor and the direct memory access controller to perform the transfer of another divided program to the first memory and the transfer of the divided program from the first memory to the second memory, respectively. Thus, in comparison with a case in which the transfer of another divided program to the first memory and the transfer of the divided program from the first memory to the second memory are performed only by the processor, the transfer time can be reduced.

Additionally, the processor can have extra processing power, and the processor can perform another operation.

[9] In [7] or [8], the processor may include the first memory inside. In this case, in comparison with a case in which an external memory connected to the outside of the processor is used, the transfer time of the divided program to the first memory can be reduced, and the time required until the control program is written to the second memory can be reduced.

[10] With respect to a method of controlling an optical transceiver according to another aspect of the present disclosure, the method of controlling the optical transceiver that can communicate with a host device through a serial communication bus, and that includes a signal processor configured to process an electrical signal, a photoelectric converter configured to perform conversion between the electrical signal and an optical signal, a first memory that includes a first region, a second memory accessed by the signal processor, the second memory being non-volatile, and a control program executed by the signal processor being stored in the second memory, and an internal serial communication bus that has a data transfer rate higher than a data transfer rate of the serial communication bus, includes storing a divided program received from the host device through the serial communication bus in the first region, and transferring the divided program stored in the first region to the second memory through the internal serial communication bus. The storing of the divided program in the first region includes starting storing of another divided program in a transferred region of the first region before the second memory completes an operation of writing the transferred divided program to memory cells of the second memory. The another divided program is different from the divided program, the transferred region stores a portion of the divided program stored in the first region, and the portion of the divided program is transferred to the second memory.

In this method of controlling the optical transceiver, the transfer of another divided program from the host device to the first memory can be performed in parallel with the writing of the divided program transferred from the first memory to the second memory. In other words, the divided program can be written to the second memory in the background of the transfer of another divided program to the first memory. Thus, multiple divided programs to be executed by the signal processor mounted in the optical transceiver can be written from the host device to the second memory at a high speed. For example, when updating the control program retained in the second memory, the downtime of the optical transceiver can be minimized.

### DETAILS OF THE EMBODIMENTS OF THE PRESENT DISCLOSURE

Specific examples of the optical transceiver of the present disclosure will be described with reference to the drawings in the following. Here, the present embodiments are not limited to the following description. In the following description, a symbol the same as a signal name is used for a signal line in which information such as a signal is transmitted. Unless otherwise indicated, a line having an arrowhead in the drawing indicates a signal line or a transmission path of information. Additionally, the signal line illustrated with a single line in the drawing may be multiple bits.

### First Embodiment

[Overall Configuration of the Optical Transceiver]

FIG. 1 is a block diagram illustrating an example configuration of an optical transceiver according to a first embodiment. For example, an optical transceiver 100 illustrated in FIG. 1 includes a central processing unit (CPU) 10, a DSP 20, an EEPROM 30, and a photoelectric converter 40. The photoelectric converter 40 includes a laser diode (LD) driver 42, a laser diode (LD) 44, and a thermoelectric cooler (TEC) 46. The photoelectric converter 40 includes an avalanche photodiode (APD) 52, a bias supply 54, and a transimpedance amplifier (TIA) 56.

Hereinafter, the laser diode driver 42, the laser diode 44, and the thermoelectric cooler 46 are also referred to as the LD driver 42, the LD 44, and the TEC 46, respectively. The avalanche photodiodes 52 and the transimpedance amplifiers 56 are also referred to as the APD 52 and the TIA 56, respectively.

For example, the optical transceiver 100 is removably connected to a computer device that transmits a digital signal and receives a digital signal. The optical transceiver 100 converts a digital signal received from the computer device into an optical signal and transmits the converted optical signal through an optical cable to the optical transceiver 100 of another computer device. Additionally, the optical transceiver 100 converts an optical signal received from the optical transceiver 100 of another computer device through the optical cable into a digital signal and transmits the converted digital signal to the computer device. Hereinafter, a computer device to which the optical transceiver 100 of FIG. 1 is connected and that transmits a digital signal and receives a digital signal is referred to as the host device 200.

The CPU 10 includes various communication interfaces and peripheral circuitry such as a direct memory access controller (DMAC). The CPU 10 is an example of a processor. The CPU 10 including the peripheral circuitry is also referred to as a microcomputer. The CPU 10 controls the DSP 20 and performs monitor control of the LD 44 and the APD 52 of the photoelectric converter 40.

Additionally, the CPU 10 executes write control of writing a signal processing program for the DSP 20 that is transferred from the host device 200 to the EEPROM 30. Although not particularly limited, the host device 200 and the CPU 10 are connected through a serial communication bus such as an inter-integrated circuit (I²C) bus. The signal processing program is an example of a control program and the I²C bus is an example of a serial communication bus.

When the CPU 10 updates the signal processing program for the DSP 20 stored in the EEPROM 30, the operation of the optical transceiver 100 is required to be stopped. Thus, in order to reduce the downtime of the optical transceiver 100, it is preferable to perform a process of rewiring, to the EEPROM 30, the signal processing program transferred from the host device 200, in as short time as possible.

The DSP 20 receives, from the host device 200, a parallel digital transmitting signal including information transmitted to another optical transceiver 100 or the like.

The DSP 20 generates an analog signal, e.g., a pulse amplitude modulation (PAM) 4 signal or the like, based on the received digital transmitting signal, and outputs the generated analog signal to the LD driver 42. Additionally, the DSP 20 receives, from the TIA 56, an analog signal such as the PAM4 signal converted from the optical signal received from another optical transceiver 100 or the like. The DSP 20 converts the received analog signal to a parallel digital received signal and outputs the converted received digital signal to the host device 200.

The DSP 20 is an example of a signal processor. For example, the digital transmitting signal and the digital received signal are non-return-to-zero (NRZ) signals. Here, the conversion between the digital signal and the PAM4 signal may be performed in a conversion circuit connected between the DSP 20, the LD driver 42, and the TIA 56.

The EEPROM 30 stores, for example, a signal processing program executed by the DSP 20, various parameters used for signal processing, and the like. The EEPROM 30 is an example of a second memory that is non-volatile. For example, the EEPROM 30 is a serial flash memory and is connected to the DSP 20 and the CPU 10 through the serial communication bus, such as a serial peripheral interface (SPI) bus. The SPI bus is an example of an internal serial communication bus.

The LD driver 42 drives the LD 44 based on the analog signal, such as the PAM4 signal, output from the DSP 20. The LD 44 converts the analog signal output from the DSP 20 into an optical transmitting signal and outputs the optical transmitting signal to the optical cable. For example, the optical signal output from the LD 44 is the PAM4 signal. The TEC 46 uses a Peltier element to control the temperature of the LD 44 to a predetermined range.

The APD 52 receives an optical received signal that is an optical signal transmitted by another optical transceiver 100 or the like through the optical cable. The APD 52 converts the optical received signal into a current signal and outputs the current signal to the TIA 56. For example, the optical signal received by the APD 52 is a PAM4 signal. The bias supply 54 supplies a bias to the APD 52. The TIA 56 amplifies a small current signal received from the APD 52 and outputs the amplified current signal as a voltage signal (an analog received data signal) to the DSP 20.

[Internal Configuration of the CPU]

FIG. 2 is a block diagram illustrating an example of an internal configuration of the CPU 10 of FIG. 1. The CPU 10 includes at least one CPU core 11, an I²C interface (I/F) 12, a DMAC 13, an SPI interface (I/F) 14, an internal random access memory (RAM) 16, and a memory bus 18. The memory bus 18 is a common bus commonly used by the CPU core 11 and the DMAC 13. The CPU core 11 and the DMAC 13 of the CPU 10 constitute a transfer part 17.

The CPU 10, more specifically the CPU core 11, for example, executes a transfer control program to perform control of transfer of a signal processing program to be executed by the DSP 20 from the host device 200 to the EEPROM 30. That is, the transfer part 17 transfers, to the EEPROM 30, divided programs transferred from the host device 200 by the CPU 10, more specifically the CPU core 11, executing the transfer control program. With this configuration, for example, when the specification of the EEPROM 30 is changed, by changing the transfer control program according to the specification of the new EEPROM 30, the CPU 10 can sequentially transfer the divided programs to the EEPROM 30 and write the divided programs to memory cells.

For example, the host device 200 is connected to the CPU 10 through the I²C bus and sequentially transfers divided programs, obtained by dividing the signal processing program into multiple pieces, to the CPU core 11 through the I²C interface 12. The size of the divided program is predetermined depending on the size of the buffer area for the divided program that can be allocated to the internal RAM 16 and the data size that can be written (programmed) by the EEPROM 30 at one time. In the present embodiment, one divided program has a size of 256 bytes.

Additionally the CPU core 11 executes a monitor control program to monitor the state of the photoelectric converter 40. For example, the transfer program and the monitor control program are stored in the internal RAM 16. The CPU core 11 that executes the transfer control program and the CPU core 11 that executes the monitor control program may be the same or different from each other.

The I²C interface 12 is connected to the host device 200 through the I²C bus and transmits information received from the host device 200 to the CPU core 11. Here, the I²C interface 12 can perform not only transfer of information from the host device 200 to the CPU core 11 but also transfer of information from the CPU core 11 to the host device 200.

The DMAC 13 transfers data from the internal RAM 16 to the SPI interface 14 based on an instruction from the CPU core 11. The data transferred by the DMAC 13 to the SPI interface 14 includes a control instruction (a command and an address) for operating the EEPROM 30 and a divided program to be written to memory cells of the EEPROM 30. Here, the DMAC 13 may transfer data between a source device such as the internal RAM 16 and another destination device based on an instruction from the CPU core 11. The internal RAM 16 may also be used as the destination device.

As described above, the transfer of the divided program to the internal RAM 16 and the transfer of the divided program from the internal RAM 16 to the EEPROM 30 can be assigned to the CPU core 11 and the DMAC 13, respectively. Thus, in comparison with a case in which the transfer of the divided program to the internal RAM 16 and the transfer of the divided program from the internal RAM 16 to the EEPROM 30 are executed by only the CPU core 11, the transfer time can be reduced. Additionally, the CPU core 11 can have extra processing power, and the CPU core 11 can perform another processing.

The SPI interface 14 is connected to the EEPROM 30 through the SPI bus and transmits data received from the DMAC 13 to the EEPROM 30. Here, the SPI interface 14 can perform not only transfer of data from the DMAC 13 to the EEPROM 30, but also transfer of data from the EEPROM 30 to the DMAC 13.

When an access request of the internal RAM 16 by the CPU core 11 and an access request of the internal RAM 16 by the DMAC 13 conflict with each other, the arbiter 15 gives a bus privilege to one of the CPU core 11 and the DMAC 13 to allow the access of the internal RAM 16.

The internal RAM 16 has an EEPROM command region and a buffer region that is allocated to be contiguous to the EEPROM command region. In the EEPROM command region, a control instruction (a command and an address) for controlling the operation of the EEPROM 30 is stored, and in the buffer region, a divided program is stored. Additionally, the internal RAM 16 includes a register region that includes a command register and a status register. The command register and the status register are used to control the transfer of the signal processing program from the host device 200 to the EEPROM 30. The internal RAM 16 is an example of a first memory. The EEPROM command region is an example of a second region, and the buffer region is an example of a first region. Here, the first memory is not limited to the internal RAM 16. For example, a memory external to the CPU 10 may be used as the first memory as long as the memory is a high-speed memory that can perform data transfer at a necessary timing.

By storing the divided program in the buffer region allocated to the internal RAM 16 mounted in the CPU 10, the transfer time of the divided program can be reduced in comparison with a case in which the divided program is stored in the buffer region allocated to the external memory. For example, the transfer time of the divided program to the buffer region can be reduced, and the transfer time of the divided program from the buffer region to the EEPROM 30 can be reduced. As a result, the transfer time of the divided program from the host device 200 to the EEPROM 30 can be reduced, and the time required until the signal processing program has been written to the EEPROM 30 can be reduced.

For example, the EEPROM command region is assigned to 0FFCh-0FFFh (4 bytes) of a CPU address. Here, “h” at the end of the address indicates that a value is hexadecimal. The CPU address is an address that is allocated to the memory space, and that can be used by the CPU core 11 and the DMAC 13. The buffer region is allocated to 1000h-10FFh (256 bytes) contiguous to the EEPROM command region. Additionally, the buffer region is assigned to 8Ch of a slave address. The slave address is an address identified by the host device 200.

The EEPROM 30 performs a program operation to write the divided program stored in the buffer region to the memory cells based on the control instruction (a write command such as a page program command) transferred from the EEPROM command region. The write instruction includes a write instruction code and a start address used to write the divided program. For example, one page, which is the unit of writing, is set to 256 bytes.

The EEPROM 30 sequentially writes multiple divided programs transferred from the CPU 10 to a memory block that includes multiple non-volatile memory cells. This stores a signal processing program obtained by combining the multiple divided programs in the EEPROM 30 in a non-volatile manner. After the signal processing program is stored in the EEPROM 30, the optical transceiver 100 is started and the DSP 20 performs signal processing by fetching the signal processing program stored in the EEPROM 30.

By allocating the EEPROM command region and the buffer region to a CPU address contiguous memory region, the control instruction and the divided programs can be continuously transferred to the EEPROM 30 by DMA transfer based on one transfer instruction. Additionally, the EEPROM 30 may perform a program operation to write the divided program to the memory cells based on the write command and the divided program that are received successively.

In other words, the write command and the divided program can be continuously transferred to the EEPROM 30 by DMA transfer specifying one start address and the divided program can be written to the memory cells. This reduces the time until the signal processing program obtained by combining the divided program has been written to the memory cells of the EEPROM 30.

The command register is assigned to 1200h of the CPU address and to the first byte of 80h (80h/0) of the slave address. The status register is assigned to 1201h of the CPU address and to the second byte of 80h (80h/1) of the slave address.

When the divided program is written from the host device 200 to the EEPROM 30, the command register is set to “WR” by the host device 200. When a command from the host device 200 is acceptable, the status register is set to “Idle” by the CPU core 11. Additionally, when a command from the host device 200 is executed, the status register is set to “Busy” by the CPU core 11. The status register can be referred to by the host device 200 so that the host device 200 can detect the operating state of the CPU 10.

[Status Check Before the Transfer of the Divided Program]

FIG. 3 is an operation sequence diagram illustrating an example of a status check when the divided program is transferred from the host device 200 to the CPU 10. The CPU core 11 writes “idle” to the status register (80h/1) when a command from the host device 200 is acceptable ((a) in FIG. 3).

When the host device 200 transfers the divided program, for example, the host device 200 polls the status register at a predetermined frequency (a status check) and waits until the status register is changed from “Busy” to “Idle” ((b) in FIG. 3). When the host device 200 detects “Idle” of the status register, the host device 200 writes “WR” to the command register (80h/0) ((c) and (d) in FIG. 3).

The CPU core 11 detects “WR” written to the command register by the host device 200 and writes “Busy” to the status register ((e) and (f) in FIG. 3). When the host device 200 detects that the status register has changed from “Idle” to “Busy” after writing “WR” to the command register, the host device 200 determines that the divided program can be transferred to the EEPROM ((g) in FIG. 3). As illustrated in FIGS. 4 to 7, the host device 200 starts the transfer process of the divided programs ((h) in FIG. 3).

When the transfer process of the divided programs is completed, the CPU core 11 writes “Complete” indicating the completion of the transfer process to the status register ((i) in FIG. 3). When the host device 200 detects “Complete” of the status register, the host device 200 detects that the divided programs have been transferred to the EEPROM 30 (FIG. 3(j)). Subsequently, when the host device 200 detects “Idle” of the status register, the host device 200 determines that a next command can be issued.

<Transfer of the Divided Programs to the EEPROM>

FIGS. 4 to 7 are explanatory diagrams illustrating an example in which the CPU 10 transfers, to the EEPROM 30, the divided programs transferred from the host device 200 to the CPU 10. FIGS. 4 to 7 illustrate an example of a method for controlling the optical transceiver. In FIGS. 4 to 7, the thick solid line indicates a path through which data or the like is transferred, and the dashed line indicates that data or the like is not transferred. The thick frame indicates data to be transferred or to be set.

First, in an operation A of FIG. 4, the host device 200 specifies the slave address 8Ch and serially transfers a first 256-byte divided program (1) to the I²C interface 12 through the I²C bus ((a) in FIG. 4). The I²C interface 12 transfers the received divided program (1) to, for example, a First-In First-Out (FIFO) buffer ((b) in FIG. 4), which is not illustrated, embedded in the CPU core 11.

Each time a predetermined amount of the divided program (1) is retained in the FIFO buffer, the CPU core 11 sequentially writes the retained divided program (1) to the buffer region of the internal RAM 16 ((c) in FIG. 4). Here, the CPU core 11 writes the divided program (1) to the internal RAM 16 in order from the CPU address 1000h corresponding to the start address of the slave address 8Ch specified by the host device 200.

The transfer of the divided program (1) from the host device 200 to the CPU core 11 ((a) and (b) in FIG. 4) and the transfer of the divided program (1) from the CPU core 11 to the internal RAM 16 ((c) in FIG. 4) are performed in parallel. The shaded portion of the buffer region in FIG. 4 indicates the stored divided program (1). By continuing the transfer of the divided program (1) from the host device 200 to the CPU core 11, the shaded portion of the buffer region gradually increases, and the first 256-byte divided program (1) is stored in the buffer region of the internal RAM 16 ((d) in FIG. 4).

The 256 bytes data transfer time is obtained by adding the transition time of the start bit and the stop bit to the sum of the transfer time of (a), (b), and (c) below.

(a) a slave address (7 bits)+a write bit (1 bit)+an acknowledge (1 bit)

(b) a CPU address (8 bits)+an acknowledge (1 bit)

(c) data (256 bytes=2048 bits)+an acknowledge per byte (1 bit)

On the assumption that the clock of the I²C interface 12 is 400 kHz (1 clock cycle=2.5 μs) and the transition time of the start bit and stop bit is 0.6 μs, the transfer time of 256 bytes is 5806.2 μs.

Next, in an operation B of FIG. 4, the host device 200 transfers the 256th byte of the first divided program (1) ((e) in FIG. 4). Then, the CPU core 11 transfers the 256th byte of the first divided program (1) to the internal RAM 16 ((f) in FIG. 4). When the transfer of the 256th byte of the first divided program (1) is completed, the CPU core 11 detects that the transfer is completed. The CPU core 11 can detect the transfer of the 256th byte as a response process of the I²C. When the CPU core 11 detects that the transfer has been completed, an operation C and an operation D of FIG. 5 are performed.

When the transfer of the 256th byte of the first divided program (1) is completed, the host device 200 waits for a certain period of time, for example, 100 ns. The certain period of time for the wait is required to be longer than or equal to a time duration required for the CPU core 11 described later to perform the operations C and D.

When the CPU core 11 detects the transfer of the 256th byte, the CPU core 11 can immediately start the operations C and D, because the response process of the I²C is used. The CPU core 11 performs the operation C by writing a write setting to the internal RAM 16. The CPU core 11 performs the operation D by writing, to the register, a transfer instruction to the DMA controller. Thus, the CPU core 11 can perform each of the write setting and the transfer instruction to the DMA controller with one instruction.

If the CPU core 11 is operating, for example, at 80 MHz clocks, it is conceivable that the write setting and the transfer instruction to the DMA controller described above is completed at up to 8 clocks. Therefore, the CPU core 11 can perform the write setting and the transfer instruction to the DMA controller for 100 ns or less.

In the operation C of FIG. 5, the CPU core 11 sets a write instruction to be transferred to the EEPROM 30 in a region of 0FFCh-0FFFh of the CPU address ((a) in FIG. 5). For example, a first byte of the write instruction indicates an instruction (a write instruction code) of the program operation to write data to the memory cells of the EEPROM 30, to the EEPROM 30, and second to fourth bytes indicate a write address (a start address). For example, the write address is set to “0”.

Next, in the operation D of FIG. 5, the CPU core 11 issues a transfer start request to the DMAC 13 together with a start address (0FFFCh) of the transfer source and a write size (260 bytes) ((b) in FIG. 5).

Here, in the operation B of FIG. 4, the transfer of the 256th byte is detected. However, for example, the transfer of a byte prior to the 256th byte may be detected, and the operation C and the operation D may be performed. By detecting the transfer of the byte prior to the 256th byte and performing the operation C and the operation D, the waiting time of the host device 200 can be reduced or eliminated. Here, with respect to which byte prior to the 256th byte is used to start the operation C and the operation D, it is defined such that a region used by the SPI interface 14 for transfer does not overlap a region used by the I²C interface 12 for transfer.

Here, the operation A and the operation B illustrated in FIG. 4 are an example of a step of storing the divided program received from the host device 200 through the serial communication bus (the I²C interface 12) in the region of the internal RAM 16.

Next, in an operation E of FIG. 6, the DMAC 13 transfers, to the EEPROM 30 through the SPI interface 14, the write instruction stored in 4 bytes from the CPU address 0FFCh. Subsequent to the transfer of the write instruction, the DMAC 13 starts the transfer of the divided program (1) retained at and after the CPU address 1000h to the EEPROM 30 ((a) in FIG. 6). That is, the DMAC 13 continuously transfers the write instruction and the divided program (1) to the EEPROM 30.

As described above, the EEPROM command region and the buffer region are allocated to a contiguous address memory region. Thus, the DMAC 13 can continuously transfer the write instruction (the write instruction code and the start address) and the divided program to the EEPROM 30.

Next, in an operation F of FIG. 6, the DMAC 13 continues the transfer of the divided program (1) to the EEPROM 30 ((b) in FIG. 6). In the buffer region from the CPU address 1000h in the internal RAM 16, the white region on the shaded region indicates a region where the transfer by the DMAC 13 is completed ((c) in FIG. 6).

Here, the operations C and D illustrated in FIG. 5 and the operations E and F illustrated in FIG. 6 are an example of a step of transferring the divided program stored in the region of the internal RAM 16 to the EEPROM 30 through the internal serial communication bus (the SPI interface 14).

Next, in an operation G of FIG. 7, after waiting for the certain period, the host device 200 specifies the slave address 8Ch and serially transfers the next 256-byte divided program (2) to the CPU core 11 through the I²C bus ((a) and (b) in FIG. 7). The CPU core 11 sequentially writes the divided program (2) transferred from the host device 200, to the buffer region of the internal RAM 16 in order from the start address (0FFFCh) ((c) in FIG. 7). The DMAC 13 continues the transfer of the divided program (1) to the EEPROM 30 ((d) in FIG. 7).

That is, before the transfer of the divided program (1) to the EEPROM 30 is completed, the transfer of the divided program (2) to the internal RAM 16 starts. More specifically, before the transfer of the divided program (1) to the EEPROM 30 is completed, in the internal RAM 16 where the divided program (1) is stored, the transfer of another divided program (2) is started in a region where the transfer of the divided program (1) is completed.

Additionally, before the writing of the divided program (1) to the EEPROM 30 is completed, the transfer of the divided program (2) to the internal RAM 16 is started. More specifically, before the writing of the divided program (1) to the EEPROM 30 is completed, in the internal RAM 16 where the divided program (1) is stored, the transfer of another divided program (2) to a transferred region, where the transfer of the divided program (1) to the EEPROM 30 is completed, is started.

For example, the SPI interface 14 transfers the 256-byte divided program (1) to the EEPROM 30 in 260 μs. With respect to this, the I²C interface 12 writes the 256-byte divided program (2) to the internal RAM 16 through the CPU core 11 in about 5800 μs. That is, the data transfer rate of the SPI interface 14 is 20 times greater than the data transfer rate of the I²C interface 12 or greater, and the reading rate of the divided program (1) from the internal RAM is higher than the writing rate of the divided program (2) to the internal RAM 16.

When the host device 200 checks the status register, it takes several microseconds. Thus, the time duration required until the host device 200 starts the I²C transfer of the next divided program after the I²C transfer of the divided program can be reduced in comparison with a case in which the status register is checked. As a result, the transfer time of the signal processing program divided into multiple divided programs from the host device 200 to the EEPROM 30 can be reduced.

FIG. 8 is an operation sequence diagram illustrating an example in which the CPU 10 transfers, to the EEPROM 30, the signal processing program for the DSP 20 transferred from the host device 200. For operations substantially the same as the operations in FIGS. 4 to 7, the detailed description is omitted.

The host device 200 specifies the slave address 8Ch and serially transfers the 256-byte divided program (1) to the CPU core 11 through the I²C bus and the I²C interface 12 ((a) in FIG. 8). The CPU core 11 sequentially writes the divided program (1) transferred from the host device 200, to the internal RAM 16 in order from the start address (0FFFCh) ((b) in FIG. 8).

The host device 200 that has completed the transfer of the 256-byte divided program (1) waits for the certain period of time, for example, 100 ns. When the CPU core 11 checks that the writing of the 256th byte of the divided program to the internal RAM 16 is completed, the CPU core 11 writes the write instruction (the write instruction code and the start address) to the CPU address 0FFCh-0FFFh ((c) in FIG. 8). The CPU core 11 issues a transfer start request to the DMAC 13 together with the start address (0FFFCh) of the transfer source and the write size (260 bytes) ((d) in FIG. 8).

The DMAC 13 starts DMA transfer of the write instruction and the divided program (1) in response to the transfer start request from the CPU core 11 ((e) in FIG. 8). That is, the DMAC 13 continuously transfers the write instruction and the divided program (1) to the EEPROM 30.

After waiting for the certain period of time, the host device 200 transfers the next 256-byte divided program (2) to the CPU core 11 through the I²C bus and the I²C interface 12 ((f) in FIG. 8). The CPU core 11 sequentially writes, to the internal RAM 16, the divided program (2) transferred from the host device 200 ((g) in FIG. 8).

Here, a region of the internal RAM 16 in which the CPU core 11 writes the divided program (2) is a region in which the divided program (1) that has been transferred is previously stored. Therefore, even while the DMAC 13 is transferring the divided program (1), the CPU core 11 can transfer the divided program (2). That is, the CPU core 11 starts to store the divided program (2) transferred from the host device 200 in the internal RAM 16 before the transfer of the divided program (1) to the EEPROM 30 through the SPI bus is completed by the DMAC 13. The transfer of the divided program (1) to the EEPROM 30 by DMAC 13 ends when the writing of the divided program (2) to the internal RAM is completed by approximately 5% ((h) in FIG. 8).

The EEPROM 30 starts the program operation to write the divided program (1) in the memory cells after the reception of the 256-byte divided program (1) is completed ((i) in FIG. 8). The execution time of the program operation is about 3000 μs. The sum of the transfer time of one divided program to the EEPROM 30 and the write operation time of the EEPROM 30 is about 3260 μs.

The sum of the transfer time of one divided program to the EEPROM 30 and the program operating time is less than the transfer time of one divided program by I²C interface 12 (about 5800 μs). Therefore, the next divided program (2) is not transferred to the EEPROM 30 before the writing operation of the divided program (1) to the EEPROM 30 is completed.

FIG. 9 is a timing diagram illustrating an example of the transfer of the divided program from the host device 200 to the internal RAM 16 and the transfer of the divided program from the internal RAM 16 to the EEPROM 30. For operations substantially the same as the operations in FIGS. 4 to 8, the detailed description is omitted. In FIG. 9, the thick solid line indicates the data transfer from the host device 200 to the internal RAM 16 by using a path that includes the I²C bus. The thick dashed line indicates the data transfer from the internal RAM 16 to the EEPROM 30 by DMAC 13 by using a path that includes the SPI bus. The rectangular frame of the dash-dot-dash line indicates the write operation (the program operation) of the EEPROM 30.

First, the host device 200 sequentially writes the 256-byte divided program (1), for a duration of about 5800 μs, to the internal RAM 16 through the I²C bus, the I²C interface 12, and the CPU core 11 ((a) in FIG. 9). After the divided program (1) is stored in the internal RAM 16, the CPU core 11 writes the write instruction to the internal RAM 16 and starts the DMAC 13.

The DMAC 13 transfers the write instruction and the divided program (1) to the EEPROM 30, for a duration of about 260 μs, through the SPI interface 14 and the SPI bus ((b) in FIG. 9). The EEPROM 30 performs the program operation (block write) of writing the divided program (1) to the memory cells, for a duration of about 3000 μs, in response to the received write command ((c) in FIG. 9).

The host device 200 starts the transfer of the next divided program (2) to the internal RAM 16 after the DMAC 13 starts the transfer of the divided program (1) from the internal RAM 16 to the EEPROM 30 ((d) in FIG. 9). That is, the transfer of the divided program (2) to the internal RAM 16 is started before the transfer of the divided program (1) to the EEPROM 30 is completed. Additionally, the transfer of the divided program (2) to the internal RAM 16 is started before the writing of the divided program (1) to the EEPROM 30 is completed. Because the transfer rate of the SPI is greater than the transfer rate of the I²C, the overwriting of the divided program (1) in the internal RAM 16 by the divided program (2) can be prevented.

As described above, the transfer of the divided program (2) from the host device 200 to the internal RAM 16 and the writing of the divided program (1) transferred from the internal RAM 16 to the EEPROM 30 can be performed in parallel. In other words, the previous divided program can be written to the EEPROM 30 in the background of the transfer of the next divided program to the internal RAM 16.

Thus, the divided programs obtained by dividing the signal processing program, to be executed by the DSP 20 mounted on the optical transceiver 100, into multiple pieces can be written from the host device 200 to the EEPROM 30 at high speed. For example, when updating the signal processing program retained in the EEPROM 30, the downtime of the optical transceiver can be minimized.

Additionally, the transfer time over the I²C interface 12 (about 5800 μs) is longer than the sum of the transfer time over the SPI interface 14 and the write time to the memory cells of the EEPROM 30 (about 3260 μs). Thus, when the transfer, to the internal RAM 16, of the divided program (2) transferred from the host device 200 is completed, the writing of the divided program (1) to the memory cells of the EEPROM 30 is completed.

Here, in the optical transceiver 100 (FIG. 1) of the present embodiment, the time duration required to write the signal processing program to the EEPROM 30 will be examined. The time duration required to transfer one divided program through the I²C interface 12 is represented as ta. The time ta is, for example, 5800 μs. The time duration required to transfer one divided program through the SPI interface 14 is represented as tb. The time tb is, for example, 260 μs. The time duration required to program one divided program into the EEPROM 30 is represented as tc. The time tc is, for example, 3000 μs. The time duration required for the host device 200 to check status by using the I²C interface 12 is represented as td. The time td is, for example, 1000 μs. The number of the divided programs is represented as N. The number of the divided programs N is, for example, 1024.

In the optical transceiver 100 of the present embodiment, when the divided program is transferred from the host device 200 to the optical transceiver 100 by using the I²C interface 12, the divided program is written to the EEPROM 30 in parallel. Thus, the signal processing program can be transferred from the host device 200 and written to the EEPROM 30 for a time duration approximately equal to the time duration required to transfer the divided program from the host device 200 to the optical transceiver 100 by using the I²C interface 12. That is, in the optical transceiver 100 of the present embodiment, the time duration required to transfer the signal processing program from the host device 200 and write the signal processing program to the EEPROM 30 is ta×N.

With respect to the above, as a comparative example, a case, in which the transfer through the I²C interface 12, the transfer through the SPI interface 14, and the writing to the EEPROM 30 are sequentially performed, will be described. Here, in order to check the completion of the writing to the EEPROM 30, it is assumed that the host device 200 checks the status once by using the I²C interface 12. In a comparative example, the time duration required at least to transfer the signal processing program from the host device 200 and to write the signal processing program to the EEPROM 30 is (ta+tb+tc+td)×N. Here, the status check may be performed more than once, but in this case, the examination assumes that the status check is performed only once.

Based on the above-described result of the examination, the optical transceiver 100 of the present embodiment can perform the processing in the processing time of about 60% (=ta/(ta+tb+tc+td)×100) relative to the comparative example. Further, assuming that the status check is performed multiple times in the comparative example, the optical transceiver 100 of the present embodiment can perform the processing in less processing time relative to the comparative example.

As described above, according to the present embodiment, the divided program is transferred from the internal RAM 16 to the EEPROM 30 by using the SPI interface 14, which has a higher data transfer rate than the I²C interface 12. Therefore, the transfer of the divided program from the host device 200 to the internal RAM 16 can be performed in parallel with the write, to the EEPROM 30, of the divided program transferred from the internal RAM 16 to the EEPROM 30. In other words, the divided program stored in the internal RAM 16 can be written to the EEPROM 30 in the background of the transfer of the next divided program to the internal RAM 16.

This can reduce the time required until the signal processing program is written to the EEPROM 30 when the divided programs obtained by dividing the signal processing program into multiple pieces is sequentially written from the host device 200 to the memory cells of the EEPROM 30, compared with a conventional method. That is, the divided programs obtained by dividing the signal processing program, to be executed by the DSP mounted in the optical transceiver 100, into multiple pieces can be written from the host device 200 to the EEPROM 30 at a high speed. For example, the downtime of the optical transceiver 100 can be minimized when updating the signal processing program retained in the EEPROM 30.

Although the embodiments of the present disclosure have been described, the present disclosure is not limited to the above-described embodiments. Various alterations, modifications, substitutions, additions, deletions, and combinations can be made within the scope of the claims. They are of course within the technical scope of the present disclosure.

For example, the divided program may be transmitted from a lower-order or higher-order address, or the divided program may be transmitted in an order different from the address order. When the divided program is transmitted in an order different from the address order, information related to the address of the divided program (for example, the address itself or the number indicating the order) may be transmitted together with the divided program.

What is claimed is:

1. An optical transceiver that can communicate with a host device through a serial communication bus, the optical transceiver comprising:
a signal processor configured to process an electrical signal;
a photoelectric converter configured to perform conversion between the electrical signal and an optical signal;
a first memory that includes a first region;
a second memory accessed by the signal processor, the second memory being non-volatile, and a control program executed by the signal processor being stored in the second memory;
an internal serial communication bus that has a data transfer rate higher than a data transfer rate of the serial communication bus; and
a transfer part configured to store a divided program received from the host device through the serial communication bus in the first region and transfer the divided program stored in the first region to the second memory through the internal serial communication bus;
wherein, the transfer part starts storing of another divided program in a transferred region of the first region before the second memory completes an operation of writing, to memory cells of the second memory, the divided program transferred by the transfer part, the another divided program being different from the divided program, the transferred region storing a portion of the divided program stored in the first region, and the portion of the divided program being transferred to the second memory.

2. The optical transceiver as claimed in claim 1, wherein the transfer part starts the storing of the another divided program in the transferred region before the transfer of the divided program to the second memory through the internal serial communication bus is completed.

3. The optical transceiver as claimed in claim 1, wherein the divided program and the another divided program are programs obtained by dividing the control program.

4. The optical transceiver as claimed in claim 1,
wherein the first memory includes a second region, a control instruction to control the second memory being stored in the second region, and
wherein the first region and the second region are contiguous.

5. The optical transceiver as claimed in claim 4,
wherein, in response to receiving a write instruction and the divided program, the second memory writes the divided program to the memory cells, the write instruction being one of the control instruction, and the divided program being stored contiguous to the write instruction, and
wherein the transfer part continuously transfers the write instruction stored in the second region and the divided program stored in the first region to the second memory.

6. The optical transceiver as claimed in claim 1,
wherein a time duration required to store the divided program in the first memory is longer than a sum of a transfer time duration required to transfer the divided program stored in the first memory to the second memory and a write time duration required to write the divided program to the memory cells.

7. The optical transceiver as claimed in claim 1, further comprising a processor that includes the transfer part, the processor controlling the signal processor and the photoelectric converter,
wherein the transfer part is caused to transfer the divided program by the processor executing a transfer control program.

8. The optical transceiver as claimed in claim 7,
wherein the processor includes a direct memory access controller, and
wherein the direct memory access controller transfers the divided program stored in the first region to the second memory through the internal serial communication bus based on an instruction from the transfer control program.

9. The optical transceiver as claimed in claim 7, wherein the processor includes the first memory inside the processor.

10. A method of controlling an optical transceiver that can communicate with a host device through a serial communication bus, and that includes a signal processor configured to process an electrical signal, a photoelectric converter configured to perform conversion between the electrical signal and an optical signal, a first memory that includes a first region, a second memory accessed by the signal processor, the second memory being non-volatile, and a control program executed by the signal processor being stored in the second memory, and an internal serial communication bus that has a data transfer rate higher than a data transfer rate of the serial communication bus, the method comprising:
storing a divided program received from the host device through the serial communication bus in the first region; and
transferring the divided program stored in the first region to the second memory through the internal serial communication bus;
wherein, the storing of the divided program in the first region includes starting storing of another divided program in a transferred region of the first region before the second memory completes an operation of writing the transferred divided program to memory cells of the second memory, memory, the another divided program being different from the divided program, the transferred region storing a portion of the divided program stored in the first region, and the portion of the divided program being transferred to the second memory.
